(19) United States
(12) Patent Application Publication
(10) Pub. No.: US 2014/0301845 A1
(43) Pub. Date: Oct. 9, 2014

(54) Harnessing Flowing Fluids to Create Torque

(71) Applicants: Wallace Wright Kempkey, Seattle, WA (US); Robert Edward Breidenthal, JR., Seattle, WA (US)

(72) Inventors: Wallace Wright Kempkey, Seattle, WA (US); Robert Edward Breidenthal, JR., Seattle, WA (US)

(73) Assignee: PTEROFIN, LLC, Seattle, WA (US)

(21) Appl. No.: 14/244,657

(22) Filed: Apr. 3, 2014

Related U.S. Application Data
(63) Continuation of application No. 13/217,170, filed on Aug. 24, 2011, now abandoned.
(60) Provisional application No. 61/402,175, filed on Aug. 25, 2010.

(51) Int. Cl. F03D 7/02; F03B 15/00

(52) U.S. Cl. CPC F03D 7/02; F03B 15/00
USPC 416/139

(57) ABSTRACT

An apparatus and method for producing high output and low cost/time, sustainable energy (e.g., wind or water) via natural currents that is environmentally friendly and includes a gravity-assisted equalizing control system is provided. Wings with a large surface area can be included in the design, as well as an optional counterbalance system that synchronizes the wings' position and speed with a mechanical leverage point on the body of the device. When a fluid flows past wings of the device, the fluid flow induces motion in the wings, which causes a shaft to move, creating torque at the generator. The outcome is a coordination of harmonizing the wings pitch angle to the natural frequency of a fluids specific velocity. The device can adapt itself to the velocity of the surrounding fluid through a rotational sweeping control system that produces a more streamlined profile to maximize reliability.

### RELATED APPLICATION

This application claims the benefit of U.S. Provisional Application No. 61/402,175 filed on Aug. 25, 2010, the entire disclosure of which is hereby incorporated by reference herein in its entirety for all purposes.

### BACKGROUND

1. Field of the Invention

This invention relates generally to the field of harnessing the energy of moving fluids.

2. Description of the Related Art

There are a number of products that provide a way of generating electricity from moving fluids, such as windmills, dams, and tidal turbines. These devices can be a much better alternative than fossil fuels, natural gas, or other biofuels. However, such energy devices can have a negative impact on the environment. For example, windmills can kill coastal, migratory, or predatory birds and bats. Damns flood valleys, which can eliminate spawning grounds of fish that return to the same place every year, as well as other riverside macro- and micro-ecosystems. Additionally, the technology is expensive, and suffers from a number of other problems, including inefficiency and unreliability.

Currently, there exists no device that can generate power from both water and wind currents. Windmills will only function with wind, and dams and tidal turbines are restricted to an aqueous environment. This increases development, deployment, and maintenance costs for these suboptimal devices.

These devices also require a lot of space. A windmill requires enough space to allow its blades to spin freely, and must be positioned high enough to receive strong air currents. Since many regions impose height restriction ordinances, windmills have limited use in populated areas. A dam requires a large valley to build up enough water pressure to spin the turbines. Tidal turbines must be isolated to prevent damage to boats and swimmers.

Windmills and tidal turbines also suffer efficiency problems in too low of a current and too high of a current. In low currents, these devices are unable to spin, so no energy can be generated. In high currents, the devices risk spinning out of control, and require complicated electronic pitching and braking mechanisms. If these systems fail, there is no mechanical way for the windmill or turbine to stabilize itself, and it may undergo damage.

Additionally, windmills and tidal turbines suffer problems with disturbing the peace. Windmills and turbines can be noisy and visually intrusive. Windmills can create a strobing flicker as sunlight passes through the blades, which is known to cause seizures in humans and animals.

### SUMMARY

In various embodiments, a device and method for harnessing flowing fluids provides usable power to homes and businesses, such as those adhering to structure height or environmental restrictions. The device comprises one or more wings that pivot around a central axis attached to a generator, which can be a generator capable of generating usable power, such as electricity or pumping water, or can be a coupler capable of connecting to a generator. The wings are also attached to a control system that is configured for orienting the wing in response to both the position of the wing about the central axis and a speed of the flowing fluid.

In one implementation, the device is mounted on a base that positions the device partially underground. Alternatively, the device is mounted on a base similar to a telephone poll or a typical windmill tower. The connecting point of the structure to the device may be a bearing capable of rotating the device. The mounting system may then come forward, or into the direction that natural current is coming from, keeping the center of gravity of the project over the bearings previously mentioned.

In one implementation, the one or more wings oscillate through an arc about the central axis. In one such implementation, the control system reorients the wing according to the speed of the fluid flow and the position of the wing in the arc to maximize efficiency and reliability.

In another implementation, the one or more wings rotate around the central axis. In such an implementation, the control system reorients the wing according to the speed of the fluid flow and the position of the wing in its rotation to maximize efficiency and reliability.

In various embodiments, a rudder is attached to the central axis. This rudder remains fixed in position while the wings pivot. As the fluid flows past the rudder, it reorients the device on the base to face maximally into the fluid flow

In various embodiments, the control system is a counterweight-based apparatus. As the wings pivot around the central axis, the counterweight-based apparatus orients the wings with the assistance of a weight and gravity.

In various embodiments, the control system is a spring-based apparatus. As the wings pivot around the central axis, the spring-based apparatus orients the wings with the assistance of springs.

In various embodiments, the control system is a fluid-resistance-based apparatus. As the wings pivot around the central axis, the fluid-resistance-based apparatus orients the wings based on resisting the speed of the fluid flow.

In various embodiments, the wing is hinged at the shaft. This allows the wing to fold towards the shaft in response to debris in the fluid flow, high fluid flow speeds, or an action by the control system.

The various embodiments provide a mechanism for high output and low cost/time, sustainable energy (e.g., wind or water) via natural currents in a design that is easier to manufacture than most carbon fiber or fiberglass windmill blades at a lower price with a smaller carbon footprint. The design is more environmentally friendly, causing very little harm to the animals or ecosystem, and has a far greater overall energy output than existing technology, as it moves slower than windmills and utilizes cubic area/surface area to be converted into electricity. In addition, it has a much lower minimal amount of natural energy currents necessary for the device to run on, and its improved reliability and resistance to damage from unpredictable weather conditions reduces cost over time. The device mimics a bird's wing as it flaps through the air or a fish's fin as it propels itself through the water, given the nature and properties of the natural energy current, and is scalable to any size. The device can also be organized in wind or water farms to maximize efficiency per square acre of land in use. The device can be built half way underground, or mounted on an above-ground structure (e.g., a tall, narrow circular structure, similar to a telephone poll or typical windmill tower).

### BRIEF DESCRIPTION OF THE DRAWINGS

FIG. 1 is a front-left isometric view of a device for harnessing flowing fluids, according to one or more embodiments.

FIG. 2A is a front-left isometric view of a device with wings that oscillate through an arc about a central axis, FIG. 2B is a front-left isometric view of the device illustrated in FIG. 2A, wherein the wings have advanced in position in response to a flowing fluid, FIG. 2C is a front-right isometric view of the device illustrated in FIG. 2A, and FIG. 2D is front isometric view of the device illustrated in FIG. 2A showing different wing positions in response to a moving fluid, according to one or more embodiments.

FIG. 3A is a front-left isometric view of a device for harnessing flowing fluids, and FIG. 3B is a front-left isometric view of the device illustrated in FIG. 3A, wherein the wings have advanced position in response to a flowing fluid, according to one or more embodiments.

FIG. 4 illustrates a device for harnessing flowing fluids with three different wing positions (the columns) showing each position from three different perspectives (the rows), according to one or more embodiments.

FIG. 5A illustrates positions of an elastic connector, FIG. 5B illustrates the control system of a device, FIG. 5C illustrates a thinned neck of a device, and FIG. 5D illustrates wings of a device, according to one or more embodiments.

FIGS. 6, 7, 8, 9, 10, 11, 12, and 13A illustrate embodiments of a control system for a device for harnessing flowing fluids, while FIG. 13B illustrates wings of a device that incorporate different materials, according to one or more embodiments.

FIGS. 14A and 14B illustrate a rotating design of a device for harnessing flowing fluids, according to one or more embodiments.

FIGS. 15A and 15B illustrate a further rotating design of a device for harnessing flowing fluids, according to one or more embodiments.

FIGS. 16A and 16B illustrate a further rotating design of a device for harnessing flowing fluids, according to one or more embodiments.

FIG. 17 illustrates a further rotating design of a device for harnessing flowing fluids, according to one or more embodiments.

FIG. 18 illustrates a cutaway of a device showing exploded views of various internal mechanisms, according to one or more embodiments.

FIG. 19 illustrates a cutaway of a device showing exploded views of various internal mechanisms, according to one or more embodiments.

FIGS. 20A and 20B illustrate internal components a device, according to one or more embodiments.

FIG. 21 illustrates internal components of the shaft of a device, according to one or more embodiments.

### DETAILED DESCRIPTION OF THE EMBODIMENTS

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed device (or method) for purposes of illustration only. One skilled in the art will readily recognize from the following description that alternative embodiments of the structures and methods illustrated herein may be employed without departing from the principles described herein.

### System/Operation Overview

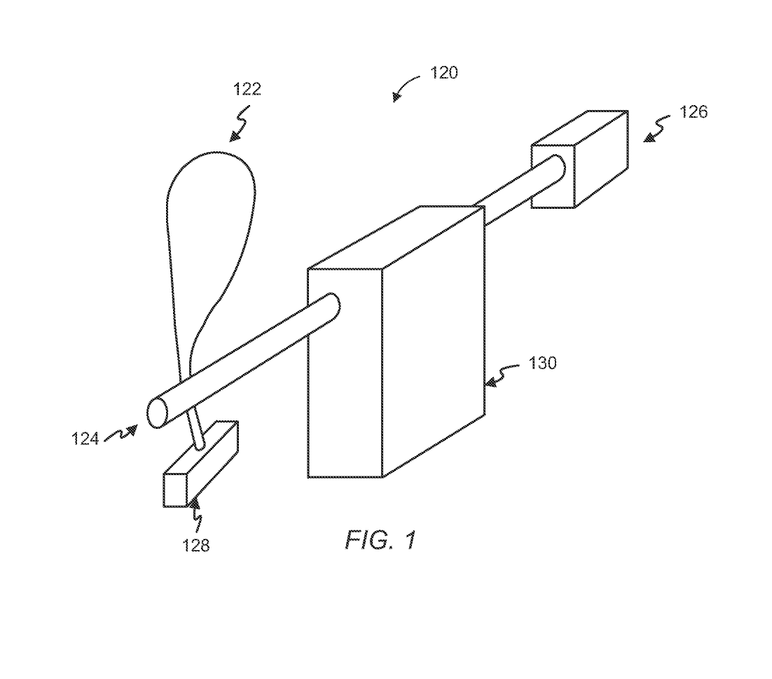

Illustrated in FIG. 1 is a front-left isometric view of a device or apparatus 120 for harnessing flowing fluids, according to one or more embodiments. The device 120 includes one or more wings 122, a shaft 124, a generator 126, a control system 128, and a base 130. When a fluid flows past the wings 122, the fluid flow induces motion in the wings, which causes the shaft 124 or a component of the shaft to move. This motion creates torque at the generator 126. For purposes of illustration, FIG. 1 shows only one wing 122, but the device 120 can include any number of wings (e.g., two, three, four, five, six, seven, eight, nine, ten, or more wings).

The wing 122 is any apparatus that will move in response to a flowing fluid. For example, the wing could be in the shape of a sail, a fin, a blade, a plane, a kite, a windmill blade, a turbine blade, a flag, a bird's wing, an insect's wing, an airplane's wing, any man-made shape, any organic/natural shape, or any other such shape. In some embodiments, it is curved or substantially curved around the edges and is designed to mimic the shape of a wing of a living organism. There can be any number of wings included, and the wings can be positioned toward the top half of the shaft, toward the bottom half of the shaft, at the sides of the shaft, or any combination of these positions. The wing can be any type of manipulatable control surface. The wing 122 is made of one or more materials that are flexible, rigid, elastic or some such desirous material property, such that, while in use, the wing can undergo various combinations of twisting, warping, sweeping, camber variation, pitch angle variation, or angle of attack variation depending on the wing design. For example, the wing can be configured to change in shape (e.g., warp, twist, bend, fold, etc.) according to how fast the fluid is moving about the device 120. In this manner, the device 120 can be designed to function without breaking or otherwise being damaged in high fluid speeds. The wing can include a stiff frame member that defines the perimeter of the wing and a flexible film or material that spans the frame. The wings can also be constructed of much stiffer and more durable materials to provide long service in environments that experience frequent, strong currents. Alternatively, the wings are constructed from photovoltaic material to add solar-power generation capability. In some embodiments, where there are at least two wings, the wings are designed to absorb energy from the flow of the fluid by generating a pressure difference between the two large surfaces of the wing, similar to the way an airplane wing generates lift. In some embodiments, the wings are designed to absorb energy from the flow of fluid by obstructing the flow, similar to the way a sailboat sail absorbs energy from the wind to propel the sailboat. In some embodiments, the wings may be staggered (e.g., by positioning the devices 120 within a wind farm so that the wings are staggered across the various devices) to allow two or more proximally located devices 120 to take advantage of the vortices produced on a moving fluid by the wings. The wings can also be lined up on a long round structure (e.g., similar to a large oil pipelines structure), so the fins could produce vortices off either side of the device, and barriers could be created or placed on either side a certain distance away to destroy the vortices to prevent erosion from occurring in streams or rivers.

The wing movably attaches to the shaft 124 in some manner, or attaches to a component (e.g., a movable or rotatable component) of the shaft. In various embodiments, the wing 122 mounts through the shaft 124 (as shown in FIG. 1), around the shaft, or directly to the shaft. The wing 122 may be positioned above (as shown in FIG. 1), below, to the side of, or any position around the shaft 124. The wing 122 attaches to the shaft using collets, spring coils, bearings, pulleys, sleeves, or any such securing mechanism known to those skilled in the art. When a fluid flows past the wing, the flowing fluid induces the wing to move substantially perpendicular to the fluid flow, which causes the shaft 124 to rotate. The wing is also attached, at least in part, to the control system 128. In various embodiments, the control system 128 acts as an intermediary between the wing 122 and the shaft 124.

The size of the wing 122 can vary depending on the design. In some embodiments, the wing 122 ranges from one to ten feet in length and one half to three feet in width and has a surface area of one to sixty feet squared. In large scale applications, such as wind farms, the wing 122 may be longer than 200 feet and wider than sixty feet with a surface area of over twenty-four thousand feet squared. In addition, for each of these numerical ranges relating to wing size, the wing size can also be any range encompassed by these ranges or any values or fractional values within these ranges.

The shaft 124 is a long, rigid rod that connects to the wing 122 and the generator 126. The shaft 124 transfers the motion of the wing 122 into torque for the generator 126. In various embodiments, the shaft attaches to the base 130 (illustrated in FIG. 1). The control system 128 may attach to the shaft 124. The shaft may include a transmission, clutch, or ratcheting gears (not illustrated) to convert oscillating motion into rotational motion. In some embodiments, the shaft can also include an outer covering about the internal rod that connects to the wing and generator.

The generator 126 is any apparatus that allows the device 120 to harness torque. The generator 126 is attached to the shaft 124. In various embodiments, the generator 126 is also attached to the base 130 or forms a part of the base 130. The generator 126 can be any apparatus capable of generating electrical power, for example, an electrical generator or alternator, or any apparatus capable of pumping water. The generator 126 can also be any connector capable of attaching to any apparatus capable of generating electrical power or pumping water. The generator 126 may include transmissions, clutches, flywheels, gears, or any internal moving parts of the device 120 as well as any large housing that contains those parts. In some embodiments, the generator 126 can be contained within the base 130 or positioned elsewhere on the device 120. For example, the generator 126 can be contained within or incorporated into the shaft. The generator may contain a clutch, which will only engage the generator once in a while (e.g., for every 5^{th} or 10^{th} oscillation), similar to the function of a mosquito's wings. The clutch may also disengage the generator in response to a slow fluid flow in order to maintain the oscillation of the wings, or it may disengage the generator as the device is starting to allow the wings to start oscillating.

The control system 128 is any apparatus that is capable of orienting the wing 122 or coordinating the motion of the wing with the natural energy current. The control system 128 orients the wing in response to its position around the shaft 124 and a speed of the fluid flow or the speed at which the shaft rotates. The control system 128 can also reorient the wing 122 in response to drag on the wing or debris in the fluid flow. The control system is attached at least in part to the wing 122 (as illustrated in FIG. 1), and may be attached to the shaft 124, the generator 126, or the base 130 (not illustrated). In some embodiments, the control system 128 is an external system associated with the device 120. The control system can be a completely non-electronic system or can include one or more electronic components. The control system 128 may include a spring, a counterweight, a wheel and track, an air foil, or any such mechanical device. The control system 128 may reorient the wing 122 with the assistance of gravity. In some embodiments, the control system is an unstable pitch-up system that might include a counterweight or bungee. In some embodiments, the control system includes a winding mechanism associated with the axis of the device that builds tension and includes a switch to release tension, which pitches the wing in the fluid. The control system can further include a limit switch to allow the winding to switch a portion of the energy from the tension into switching the wing movement. Since the control system controls the movement of the wings, the wing movement does not have to be controlled by the weight of the wings themselves, as is the case with some existing technology.

The control system 128 can control the movement or pivoting of the wing 122 about the shaft. In some embodiments, the wing 122 oscillates back and forth about the shaft 124 in two different directions. Where there are two wings 122, the wings can oscillate back and forth about the shaft 124 in opposite directions and can be coordinated in their movement. The wing 122 can also oscillate or rotate completely about the shaft 124. Where there is more than one wing 122, the wings can rotate about the shaft 124 in a coordinated movement. Thus, pivoting about the shaft 124 can include oscillating back and forth about the shaft (without fully rotating around the shaft) or rotating around the shaft. In some embodiments, the wing 122 has a 359 degree or less range of motion about the shaft 124. In other embodiments, the wing 122 has a 360 degree range of motion about the shaft 124. In addition, the control system 128 can be a pitch control system that is configured for orienting the wing's pitch in response to gravity acting on the wing 122 and pitch control system, as well as the position of the wing and speed at which it turns around the shaft 124. The control system 128 can further rotate the wings 122 towards the shaft to decrease drag and impact forces on the wings within the fluid. In some embodiments, the control system 128 further includes a mechanism to increase lift forces acting on the wing 122 in response to the moving fluid.

The base 130 is any apparatus that is capable of supporting the device 120. In various embodiments, the base attaches to the shaft 124 or the generator 126. The base can be anchored to the ground or a structure, such as a home, building, platform, or concrete slab, or attached to a cart on a rail or track, such as a railroad track. The base 130 can be a truss, a pole, or a pole-like structure. Alternatively, the base can be a portable and/or deployable and/or retractable antenna-like device, or a hollow structure that can be weighted down with water, rocks, sand, dirt, gravel, or any other such material. The base 130 may attach to the shaft or the generator via a bearing to allow the shaft 124 to rotate in a plane substantially parallel to the ground in order that the shaft faces substantially parallel to the direction of the fluid flow. Instead of a bearing, the base 130 may be mounted to a circular track, and move about the circle in order that the shaft faces substantially parallel to the direction of the fluid flow. The track may be built around a crater on Earth or on another planet such as Mars. The device may be configured such that the center of mass of the device is directly over the base in order to reduce the torque on the base and bearing.

In operation, the device 120 harnesses energy contained in a fluid that flows, such as air or water. The device then converts the harnessed energy into a usable form, such as electricity that can then be used to power any desired device, or a reciprocating piston that can be used as a pump to extract water from a well or to distribute water throughout a field to irrigate crops. The wing reciprocates in a direction substantially perpendicular to the flow of the fluid through a displacement of about 90 degrees, or about 45 degrees counterclockwise from a neutral position, and about another 45 degrees clockwise from the neutral position. Thus, in operation, the wings look similar to a dragonfly's wings flapping. In other embodiments, the displacement of the wing may be greater than 90 degrees or less than 90 degrees. The device converts the reciprocating motion of the wings into rotational motion of the shaft that rotates about an axis that passes though the shaft and the generator converts the energy in the rotating shaft into an electric voltage that can be used to generate electricity.

The device pivots at least one wing about the shaft in a first direction in response to the flow of fluid about the wing. The device 120 can also be designed to pivot the wing about the shaft in a second direction in response to the flow of the fluid about the wing. The first and second direction can be the same direction or the opposition direction. This pivoting in the first and second directions drives an oscillating motion of the wing (e.g., back and forth about the shaft) or a rotating motion of the wing (e.g., around the shaft). In addition, torque is exerted on the shaft from the fluid flowing about the wing when the wing has pivoted in the first direction and torque is exerted on the shaft from the fluid flowing about the wing when the wing has pivoted in the second direction. In some embodiments, where the wing is oscillating back and forth about the shaft, the pivoting in the first direction occurs as the wing approaches a first maximum position in the oscillating motion, and the pivoting in the second direction occurs as the wing approaches a second maximum position in the oscillating motion. In some embodiments, the pivoting can happen as the wing approaches the limit of its rotational path about the shaft. Upon reaching the limit of its rotational path about the shaft, the wing can then be moved in the opposite direction about the shaft until it again reaches the limit of its rotational path in this opposite direction. The wing can proceed with oscillating back and forth in a first direction and a second direction over time, switching direction as it reaches the limit of its oscillation. In some embodiments, the limit of the wings oscillation can be determined by the control system that controls how far the wing can oscillate. The ticking back and forth of the wings controls the angle of attack for the wings as the move, converting natural energy currents into electricity. Where the device is designed to rotate the wings fully around the shaft, the device can pivot at least one wing about the shaft in response to a flowing fluid and torque is exerted on the shaft from the fluid flowing about the wing when the wing has pivoted about the shaft.

In various embodiments, the wing 122 is hinged where it connects to the shaft 124 (e.g., this can permit the upper half of the device 120 to pitch back). The device 120 may instead be hinged where the shaft 124 connects to the generator 126, or where the base 130 connects to either the generator 126 or the shaft 124. Alternatively, generator 126 may be broken into two parts that are connected with a hinge. The base 130 may also be broken into two parts that are connected with a hinge. The hinge allows the wing, a part of the device, or the entire device, to fold, bend, or pivot in response to debris in the fluid flow, or an increased speed of the fluid flow. A spring or some such device may be connected between the hinged portions to prevent motion in the event of no debris in the fluid flow or a low speed of the fluid flow.

The design of the device 120 provides a variety of benefits. The device 120 is a highly-efficient and reliable energy harnesser. The control system can sweep the wing back to increase reliability or it can vary pitch or control of the wing, type of warping of the wing, etc. in a way to optimize efficiency of the device 120 in harnessing energy. Some designs include a centripetal transmission to meet demands on the axis of the device 120 at higher fluid speeds. Thus, the device 120 has a variety of protections against high fluid speeds that allow it to continue to function and/or avoid damage when unexpectedly high fluid movement occurs. While most energy harnessing devices, such as windmills, start operating only in fluid (e.g., wind) speeds of at least 10 miles per hour, this device 120 will start operation and can continue to operate in fluid (e.g., wind) speeds of 2 miles per hour. In some embodiments, the device 120 will start operating in 1, 2, 3, 4, 5, 6, 7, 8, or 9 mile-per-hour moving fluids (including ranges or fractional values in between or including these numbers). Thus, it has a much lower minimal amount of natural energy currents necessary for the device to run on, and its improved reliability and resistance to damage from unpredictable weather conditions reduces cost over time. The design is more environmentally friendly than current energy harnessing devices, causing very little harm to the animals or ecosystem, and has a far greater overall energy output than existing technology, as it moves slower than windmills and utilizes cubic area/surface area to be converted into electricity. The device can also be organized in wind or water farms to maximize efficiency per square acre of land in use. The device can also be built half way underground, or mounted on an above-ground structure.

One advantage of the device 120 over existing technology is that the non-steady wing motion can exploit Stokes boundary layer effects, whereby higher lift coefficients are achievable. It takes time for a boundary layer to separate. A sufficiently rapid increase in angle of attack will inhibit boundary layer separation so that the lift coefficient can increase well beyond its steady-state maximum. This occurs when the wing chord is approximately equal to the product of the relative wind speed and the e-folding time of rate of increase in the angle of attack of the relative wind. The chord is the length from the leading edge of the wing to the trailing edge of the wing. The e-folding time is the time it takes to increase the angle of attack by a factor of e (the natural number). If the wing chord is too small, the advection time of the boundary layer vorticity over the chord of the wing is too short compared to the e-folding time, and the flow is quasi-steady.

A further advantage of exploiting a Stokes-type boundary layer is that a cruder, less expensive airfoil shape is possible. Flow separation tends to be inhibited by the rapid pitch-up of the airfoil, even with a non-optimal airfoil section.

An advantage of the purely aerodynamic control of wing pitch is that the pitching moment is proportional to the dynamic pressure of the wind. In contrast, other mechanisms for pitch control using weights or springs of constant force or strength cannot match the aerodynamic forces and moments over as wide a range of wind speeds.

The device thus harmonizes with the natural frequency of natural energy currents or resonance of a fluid. Instead of including a wing that floats through fluid, it actually adapts to that fluid and harmonizes with it to provide maximum efficiency. The device 120 is a fluid energy device with a gravity-assisted equalizing control system. It utilizes a wing possessing a large surface area, and it can also include a counterbalance system, which synchronizes the wing position and speed with a mechanical leverage point on the body of the device 120. The outcome is a coordination and harmonization of the wing pitch angle to the natural frequency of a fluid's specific velocity. Furthermore, this device 120 is capable of adapting itself to the velocity of the surrounding fluid through a rotational sweeping control system that produces a more streamlined profile to maximize reliability.

### Oscillating System Overview

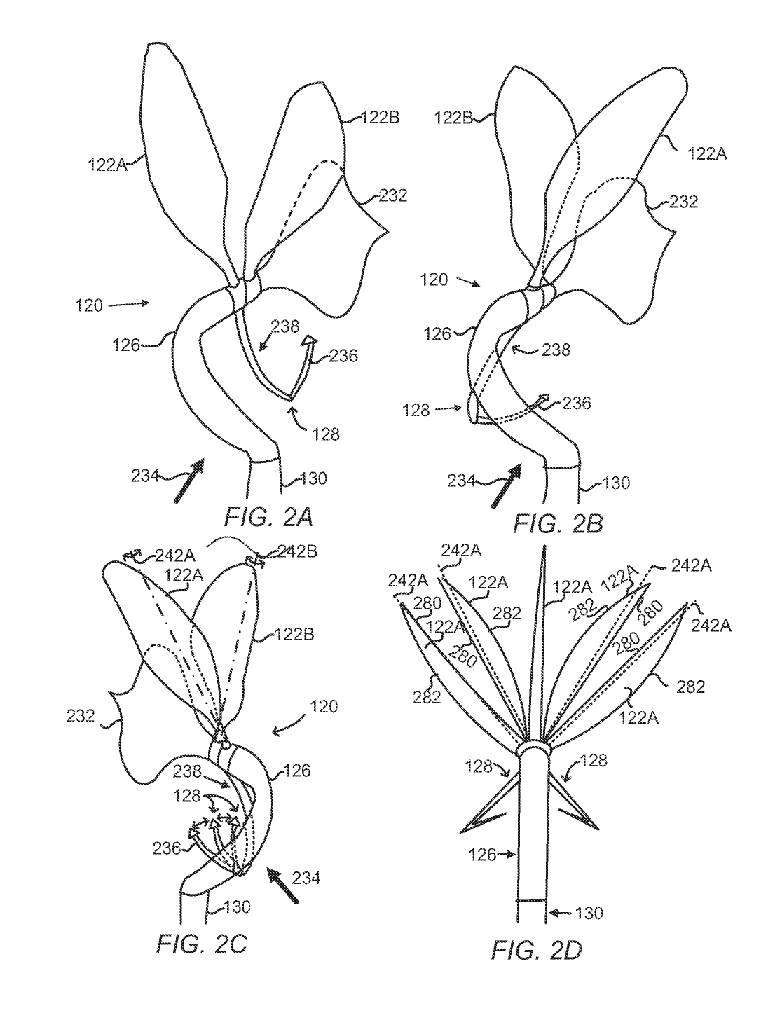

Illustrated in FIGS. 2A through 2D are various views of an embodiment of the device 120. FIG. 2A shows the embodiment of the device 120 from a front-left isometric view. The device 120 includes two wings 122, a fore wing 122A and an aft wing 122B. The fore wing 122A and aft wing 122B can be the same size and shape, or slightly different sizes and shapes to adjust the rotational torque on the base 130. The control system 128 attaches to the fore wing 122A in this embodiment. The wings 122 attach around the shaft 124 (not illustrated here). The shaft 124 can connect to the generator 126, which connects to the base 130 via a rotational bearing (not illustrated). The second end of the shaft connects to a rudder 232 in this embodiment. The rudder aligns the device 120 with the direction of the fluid flow 234. Any of the embodiments described herein can include a rudder that is attached to the base, shaft, or generator (or a combination of these) and keeps the front of the device facing into the flow of the fluid. The two wings 122 oscillate back and forth through an arc about the shaft. Depending on the configuration of the control system 128, the wings 122 may oscillate synchronously. The control system 128 includes a pendulum 236 that is pivotally mounted to an arm 238.

Referring now to FIG. 2B, as the wings 122 move away from their neutral positions, the arm 238 moves away from its neutral position located directly under the generator 126. As the arm 238 moves toward a horizontal position, the weight of the pendulum 236 causes the pendulum to pivot relative to the arm 238. Referring now to FIG. 2C, when the pendulum 236 pivots through some threshold (e.g., 45 degrees), the pendulum triggers the control system 128 to rotate each of the wings 122A and 122B about its respective axis 242A and 242B.

FIG. 2D shows the change in the angle of attack of the fore wing 122A as the wing reciprocates. As the wing 122A moves counterclockwise (to the left as viewed), the wing is positioned to provide an angle of attack such that the wing's leading edge 280 is left of the axis 242A, and the wing's trailing edge 282 is right of the axis 242A. Then, when the wing 122A reaches its maximum displacement in the counterclockwise direction, the control system 128 rotates the wing about the axis 242A to change the wing's angle of attack such that the wing's leading edge 280 is now right of the axis, and the wing's trailing edge 282 is now left of the axis. With the new angle of attack, the flow of fluid across the wing 122A urges the wing to move clockwise, back toward its neutral position. Similarly, when the wing 122A reaches its maximum displacement in the clockwise direction, the control system 128 rotates the wing about the axis 242A to change the wing's angle of attack such that the wing's leading edge 280 lies to the right of the axis 242A, and the wing's trailing edge 282 lies to the left of the axis. With the new angle of attack, the flow of fluid across the wing 122A urges the wing to again move counterclockwise, back toward its neutral position.

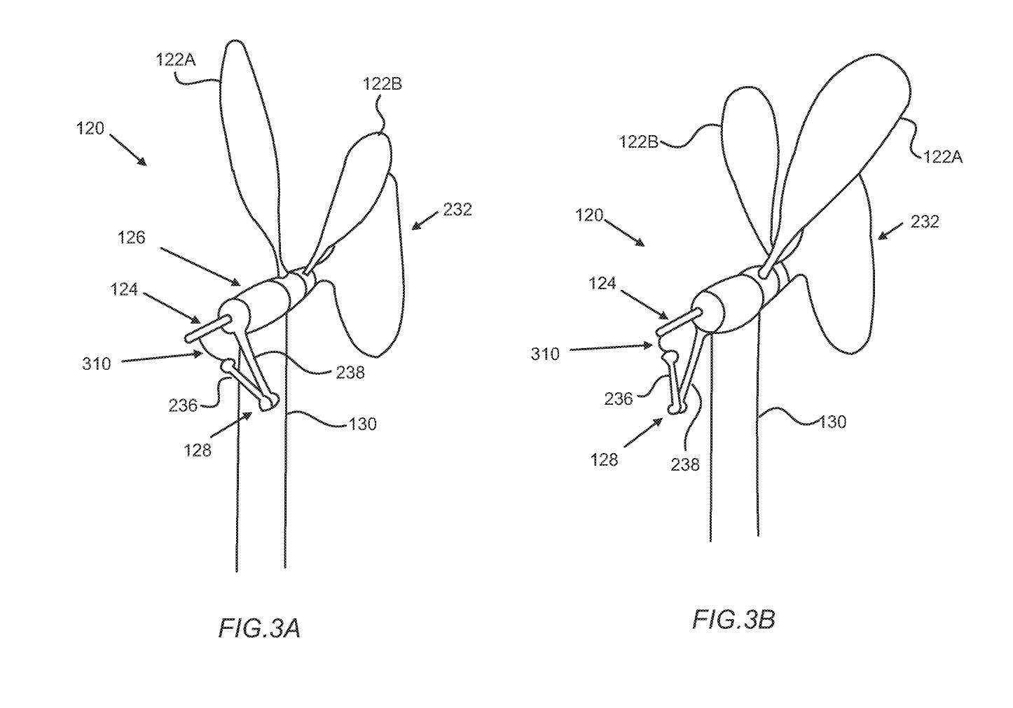

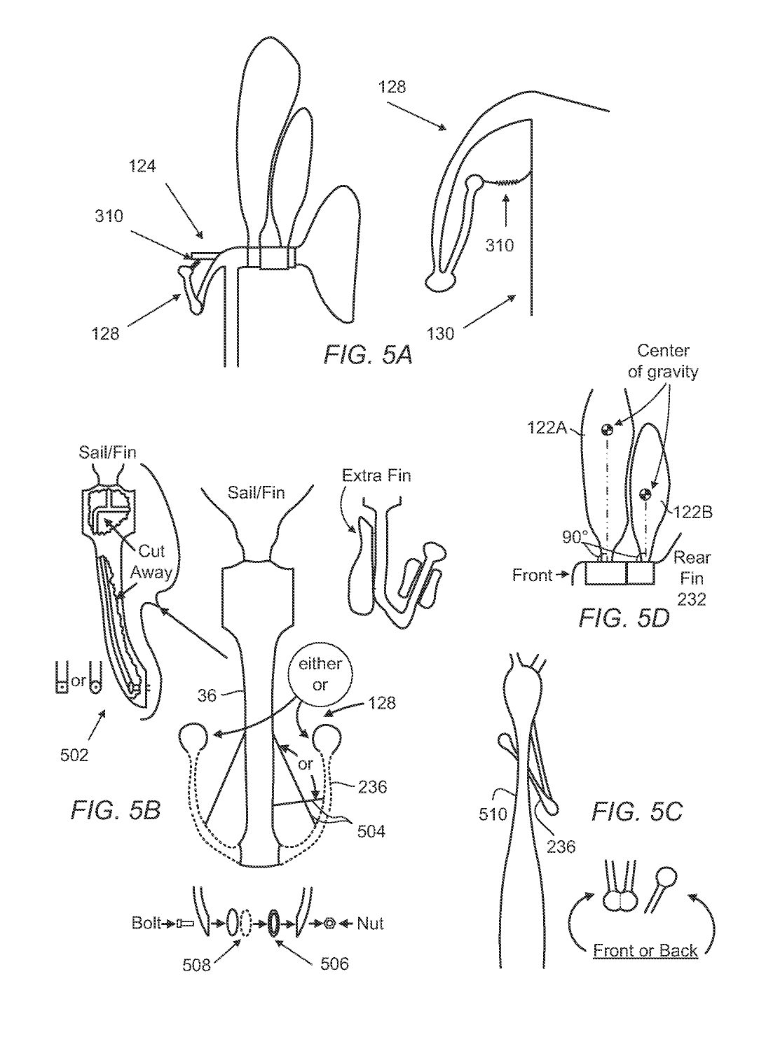

Illustrated in FIGS. 3A and 3B are various views the device 120, according to another embodiment of the invention. In this embodiment, the wings 122 and rudder 232 attach on one end of the shaft. The shaft 124 passes through the generator 126, and the generator attaches to the base 130. The control system 128 is attached to the shaft 124, as well as the wings 122 through an internal mechanism of the shaft (not illustrated). The control system 128 also attaches to the shaft via an elastic connector 310. The connector 310 is made of elastic, springs, bungee, nylon, or some such material. In various embodiments (see FIG. 5), the connector 310 can be positioned at any point along the pendulum 236 or arm 238 to allow different leverage properties based on the desired performance characteristics. Additionally, the connector 310 may connect to any of the shaft 124, generator 126 (not illustrated), or base 130.

Referring again to FIGS. 3A and 3B, the control system 128 is located ahead of the base 130 or upstream from the base when fluid flows across the wings 122A and 122B. This arrangement may be desirable in situations where the flow of fluid is fast so that the load on the arm 238 and pendulum 236 from the fluid flow remains substantially consistent as the arm and pendulum move between their maximum displacements. When the base 130 is located upstream from the arm 238 and pendulum 236, the base will obstruct the flow of fluid against the arm and pendulum when they are disposed behind the base. In such an embodiment, the control system 128 may be hinged so that, if the device bends back in response to debris or a high fluid flow, the control system 128 will not intersect the base 130.

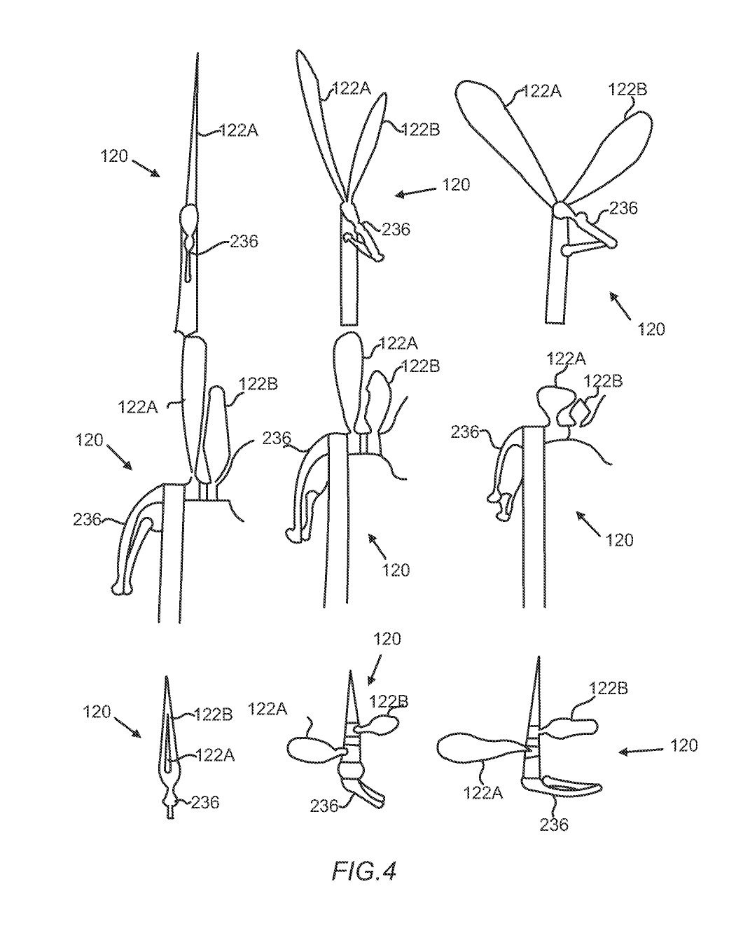

Illustrated in FIG. 4 is another embodiment of the device 120. In this embodiment, the control system 128 connects to a first end of the shaft 124 (not illustrated). The wings 122 and rudder 232 connect to a second end of the shaft 124. The control system 128 connects to the wings 122 through an internal mechanism of the shaft (not illustrated). The shaft 124 passes through the base 130, which also houses the generator 126 (not illustrated). The control system also attaches to the base via the small connector 310.

FIG. 4 shows three different positions of wings 122 (in three columns, from left to right), and shows each position from three different perspectives (in three rows, from top to bottom). The left column shows the device 120 with the wings 122 in their neutral positions, and with the pendulum 236 directly under the arm 238. The figure in the top row of the left column shows a front view of the device 120. The figure in the middle row of the left column shows a side view of the device 120. And, the figure in the bottom row of the left column shows a top view of the device 120.

The middle column of FIG. 4 shows the device 120 with the wings about halfway to their maximum displacement away from their neutral positions, and with the pendulum 236 moved relative to its position shown in the first column. The figure in the top row of the middle column shows a front view of the device 120. The figure in the middle row of the middle column shows a side view of the device 120. And, the figure in the bottom row of the middle column shows a top view of the device 120.

The right column of FIG. 4 shows the device 120 with the wings 122 at about their maximum displacement away from their neutral positions, and with the pendulum 236 similarly moved relative to its position shown in the first column. The figure in the top row of the left column shows a front view of the device 120. The figure in the middle row of the left column shows a side view of the device 120. And, the figure in the bottom row of the left column shows a top view of the device 120.

Referring now to FIG. 5A, illustrated are embodiments of different attachments of the control system 128. As described above, the control system 128 can attach to the shaft 124 via an elastic connector 310. FIG. 5 illustrates how this connector 310 can be positioned at any point along the pendulum or arm to allow different leverage properties based on the desired performance characteristics. The connector 310 may also connect to any of the shaft 124, generator 126 (not illustrated), or base 130.

Referring now to FIG. 5B, illustrated is a control system 128, according to one or more embodiments. In some embodiments, this control system 128 is a counterbalance or pendulum lever control arm. In some embodiments, the control system 128 includes an arm 238 and a pendulum 236. The pendulum 236 is pivotally mounted to the arm 238 and triggers the control system 128 to rotate each of the wings 122A and 122B about their respective axes to change each wing's angle of attack. In some embodiments, the arm 238 provides a counterweight to the weight of the wings 122A, 122B to balance the wings as they reciprocate between their respective maximum displacements in the clockwise and counterclockwise directions. The counterweight can be any size, length, weight, shape, or distance from the joint. The lever arm 238 can be any length, material, tensile strength, weight, angle, shape, size, ratio, material tension, or position on the counterbalance. In some embodiments, the counterweight is a reservoir or a cylinder or other container holding fluid. By providing such balance, a substantial portion of the fluid flow's energy that the wings absorb reaches the generator. Without the balance provided by the arm, the energy required to move each of the wings 122A, 122B against gravity would probably have to be provided by the energy absorbed from the flow of fluid.

In some embodiments, a bungee 504 can be included that can be composed of any given elastic material and can be used to keep the counterweight from swinging too high. The bungee 504 can also keep the system from rolling all the way around and damaging the wings 122A, 122B. The bungee 504 can be in various positions, including those shown in FIG. 5B. There can be multiple bungees, as well. The bungee may also have a self adjusting apparatus comprising a hydraulic piston, a spring, or some such device to automatically adjust the bungee's length in accordance with the force applied to the bungee by the system.

At the top right of FIG. 5B, there is shown a design with an extra wing or fin on the control system 128. A system of pulleys or levers can be added to create such secondary wings or fins for added efficiency on either side of the two arms to assist with reciprocating motion in the fluid. At the top left of FIG. 5B, a hydraulic pump or pulley 502 for use with the device is shown, including a cut-away view illustrating the internal components. At the bottom middle of FIG. 5B, there is shown a pendulum lever arm that can be positioned in front of a counterbalance arm, and leashed to the main structure to avoid over-rotation of the wings. A spring coil 506 can be included in this design, and it can be single- or double-spring loaded with any given size, shape, weight, tension, or play of spring. Bearings 508 are also illustrated adjacent to the spring coil 506.

Other embodiments of the control system 128 are also possible. For example, an electronic position sensor may be used to determine when each of the wings 122A, 122B have reached their maximum displacement and thus require a change in their respective attack angles. And, an electric motor may be used to rotate the wings 122A, 122B in response to a signal from the sensor. As another example, other mechanical mechanisms may be used to trigger the control system 128, and/or rotate the wings 122A, 122B to change their attack angles. In still other examples, a computer may be used to monitor environmental conditions, such as the speed, temperature and humidity (if appropriate) of the fluid flowing across the wings, and the performance variables of the wings, such as the amount of energy absorbed from the flowing fluid relative to the total amount of energy in the fluid flow. And, in response to the environmental conditions and performance variables, the computer may modify as desired the angle of attack, as well as other variables such as maximum displacement position relative to neutral.

Referring now to FIG. 5C, illustrated is a counterweight swinging past a neck of a device, such as device 120, according to one or more embodiments. The neck 510 is positioned in front of the swinging counterweights of the pendulum 236. In various embodiments, the neck 510 is designed to be as skinny as possible, while still tolerated by wind testing limits, to reduce the wobble of the weights as they pass behind the neck 510. A wind barrier could also be used to keep the wind from disrupting the movement of the counterweights in the fluid. The bottom of FIG. 5C shows the counterweights, and illustrates that the counterweights can be egg shaped to assist with aerodynamics and swinging motion.

Referring now to FIG. 5D, illustrated are wings of the device, according to one or more embodiments. The fore wing 122A and aft wing 122B can be the same size and shape, or can be different sizes/shapes depending on the accepted limits of force and torque on the shaft. Since the aft wing 122B is further away from the pivoting point of the device and has greater leverage for keeping it facing into the wind, the aft wing 122B may be smaller, as shown in FIG. 5D. The trailing edge of the wings 122A, 122B can have a control surface integrated into it, which is controlled by the same counterweight used to control the pitch of the wings and to help rotate, steer, or pitch the wings back into the fluid to assist with perpetuating the oscillating motion. Energy or work going into the trailing edge control surface of the wing coming from the counterweight lever can be spring loaded to maneuver the control surface of the wing before pitching the whole wing, to make steering the wings back into the fluid easier and more efficient.

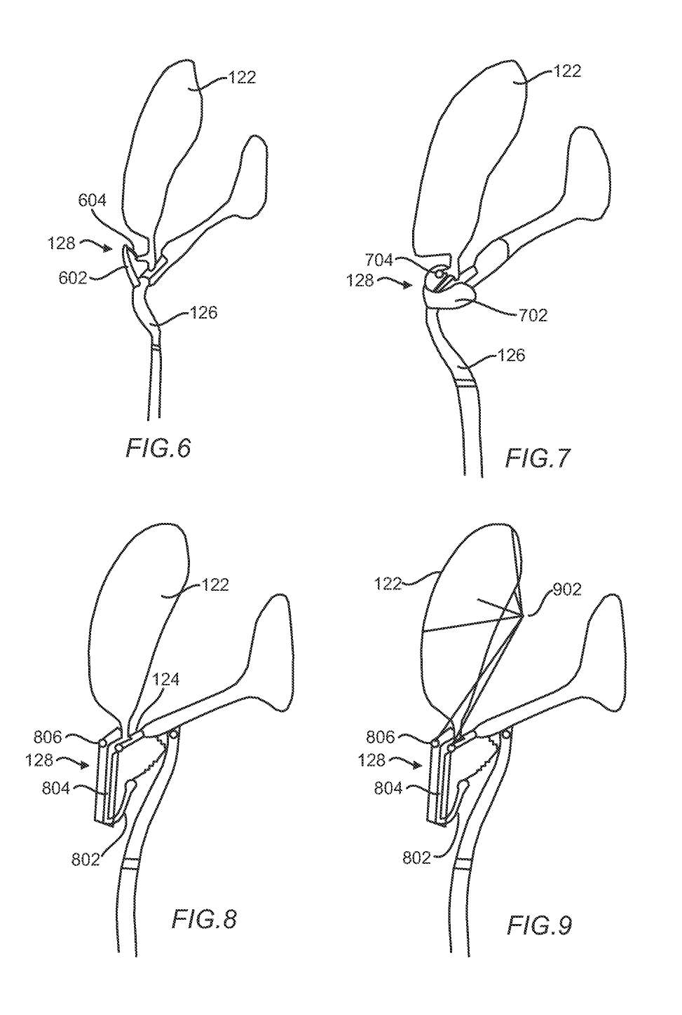

Referring now to FIG. 6, illustrated is another embodiment of a control system 128 for a device, such as the device 120 shown in FIG. 1. The control system 128 comprises an arm 602 and an elastic connector 604. The arm 602 is attached to the generator 126. The elastic connector 604 connects between the arm 602 and the wing 122. The arm 602 is any structural element that can handle the stress and torque of the elastic connector 604. The elastic connector 604 is made up of a spring, bungee, elastic, nylon, or any such material. As the wing 122 moves from the neutral position, the elastic connector 604 pulls on the wing, which rotates the wing about its axis. The flowing fluid then exerts a force on the wing, which causes it to return to and pass through the neutral position. Again, the elastic connector 604 pulls on the wing, which rotates the wing 122 the other way on its axis. The flowing fluid then exerts a force on the wing, which causes it to return to and pass through the neutral position, thereby oscillating back and forth.

Referring now to FIG. 7, illustrated is another embodiment of the control system 128 for a device, such as the device 120 shown in FIG. 1. The control system 128 comprises a U-shaped barrier 702 connected to the generator 126 and a wheel attachment 704 connected to the wing. The U-shaped barrier 702 is any U-shaped device with a groove or track or some such feature to interface with the wheel attachment 704. The U-shaped barrier 702 is attached to the generator 126. The wheel attachment 704 is an arm with a horizontal wheel. As the wing 122 moves from the neutral position, the wheel attachment 704 contacts the U-shaped barrier 702, which rotates the wing on its axis. The flowing fluid then exerts a force on the wing, which causes it to return to and pass through the neutral position. Again, wheel attachment 704 contacts the U-shaped barrier 702, which rotates the wing 122 the other way on its axis. The flowing fluid then exerts a force on the wing, which causes it to return to and pass through the neutral position, thereby oscillating back and forth.

Referring now to FIG. 8, illustrated is another embodiment of a control system 128 for a device, such as the device 120 shown in FIG. 1. The control system 128 comprises a pendulum 802, an arm 804, and a pulley system 806. The pendulum 802 includes a counterweight on an arm. The arm 804 connects to the shaft 124 and wing 122, as well as the pendulum 802 and pulley system 806. The pulley system 806 attaches to the pendulum 802, arm 804, and wing 122 through a system of lines and pulleys. As the wing 122 rotates from the neutral position, the arm 804 rotates the other direction. The causes the pendulum 802 to fall down, which pulls on the pulley system 806, which pulls on the wing 122, which rotates the wing on its axis. The flowing fluid then exerts a force on the wing, which causes it to return to and pass through the neutral position. Again, the pendulum 802 falls down, which pulls on the pulley system 806, which pulls on the wing 122, which rotates the wing on its axis. The flowing fluid then exerts a force on the wing 122, which causes it to return to and pass through the neutral position, thereby oscillating back and forth.

Referring now to FIG. 9, illustrated is a variation of a control system 128 for a device, such as the device 120 shown in FIG. 8. The pulley system 806 in this embodiment has a wing attachment portion 902 that attaches in multiple places to the wing 122. As the pendulum 802 falls down, it pulls on the pulley system 806, which instead deflects the wing 122 using the wing attachment portion 902. The deflected wing 122 responds to the flowing fluid, which causes it to return to and pass through the neutral position, thereby oscillating back and forth.

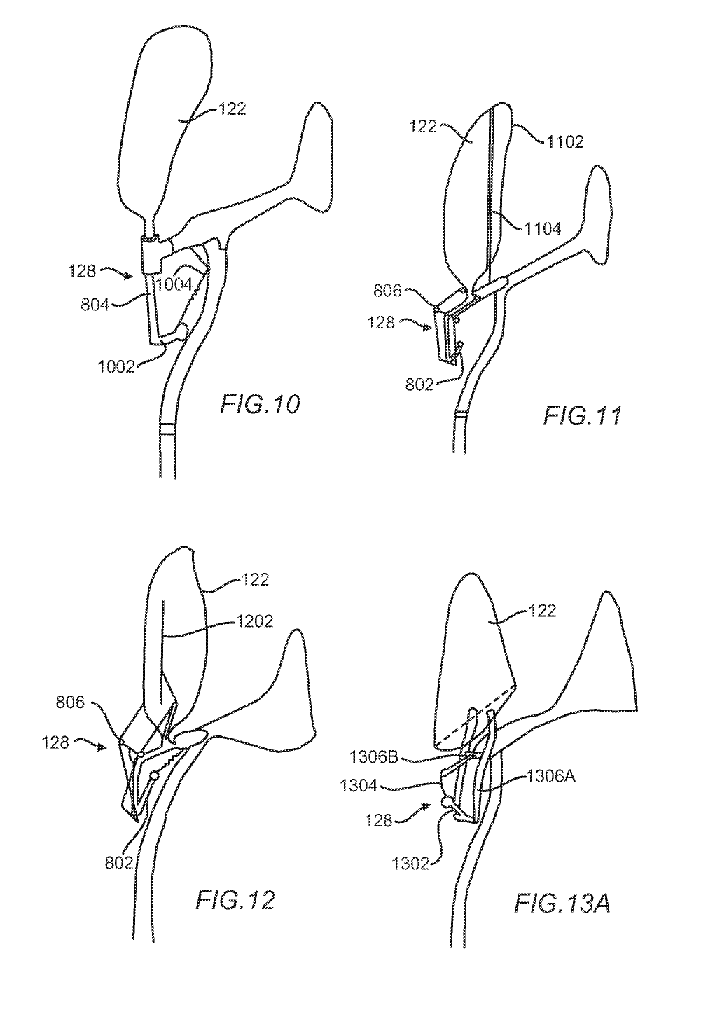

Referring now to FIG. 10, illustrated is another embodiment of a control system 128 for a device, such as the device 120 shown in FIG. 1. The control system 128 comprises a pendulum 1002, and an elastic connector 1004. The pendulum 1002 is attached to the wing 122, and comprises an arm and a counterweight. The elastic connector 1004 connects between the pendulum 1002 and the wing 122. The connector 1004 is made of elastic, springs, bungee, nylon, or some such material. The connector 1004 limits the range of motion of the pendulum 1002. As the wing 122 rotates from the neutral position, the pendulum 1002 rotates the other direction. The causes the counterweight to fall down, which rotates the wing 122 on its axis. The flowing fluid then exerts a force on the wing, which causes it to return to and pass through the neutral position. Again, this causes the counterweight to fall down, which then rotates the wing 122 on its axis. The flowing fluid then exerts a force on the wing 122, which causes it to return to and pass through the neutral position, thereby oscillating back and forth.

Referring now to FIG. 11, illustrated is a variation of a control system 128 for a device, such as the device 120 shown in FIG. 8. A control surface 1102 is attached to the rear of the wing 122 via a hinge 1104. The pulley system 806 attaches to the control surface 1102. As the pendulum 802 falls down, it pulls on the pulley system 806, which instead rotates the control surface 1102 at the hinge 1104. As the wing 122 reaches the maximum extent of its oscillation, the pulley system 806 rotates the wing on its axis. The rotated wing 122 and control surface 1102 responds to the flowing fluid, which causes it to return to and pass through the neutral position. Again, the pendulum 802 falls down, pulling on the pulley system 806, which rotates the control surface 1102 and eventually rotate the wing 122 on its axis. Again, the flowing fluid exerts a force on the rotated wing 122 and control surface 1102, which causes it to return to and pass through the neutral position, thereby oscillating back and forth.

Referring now to FIG. 12, illustrated is a variation of a control system 128 for a device, such as the device 120 shown in FIG. 9. A rigid rod 1202 is located inside of the wing 122. The wing 122 may be made up of varying materials to tune its deflections, such as fiberglass, carbon fiber, or aluminum. The pulley system connects to the rigid rod 1202 of FIG. 12. As the pendulum 802 falls down, it pulls on the pulley system 806, which instead pulls on the rigid rod, which causes the wing 122 to deflect. The deflected wing 122 responds to the flowing fluid, which causes it to return to and pass through the neutral position, thereby oscillating back and forth.

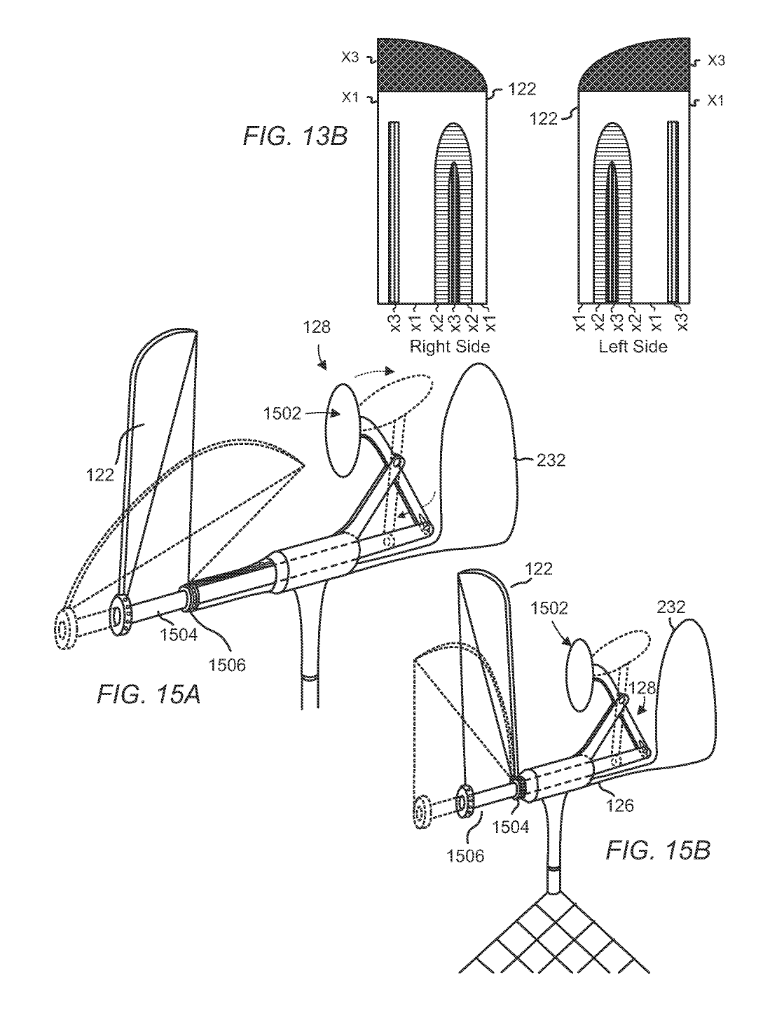

Referring now to FIG. 13A, illustrated is a variation of a control system 128 for a device, such as the device 120 shown in FIG. 1. The control system 128 comprises a pendulum 1302, an elastic connector 1304, and two arms 1306A and 1306B. The pendulum 1302 includes a counterweight, and connects between the two arms 1306. The elastic connector 1304 connects between the shaft 124 and the pendulum 1302. The connector 1304 is made of elastic, springs, bungee, nylon, or some such material. The two arms 1306 connect to the wing 122. As the wing 122 rotates from the neutral position, the arms 1306 rotate the other direction. This causes the pendulum 1302 to fall down, which causes the arms 1306 to scissor apart. This scissoring motion causes the wing 122 to deflect and/or rotate on its axis. The flowing fluid then exerts a force on the wing 122, which causes it to return to and pass through the neutral position. Again, the pendulum 1302 falls down, which scissors the arms 1306 and deflects and/or rotates the wing 122 on its axis. The flowing fluid then exerts a force on the wing 122, which causes it to return to and pass through the neutral position, thereby oscillating back and forth. As shown in FIG. 13B, different parts of the wing 122 can be made of different materials, such as including a more rigid material at the center of the wing (dark rod in the middle), with a somewhat less rigid material surrounding it (lined material surrounding the dark rod), and finally a less rigid material surrounding that and making up the bulk of the wing. Similarly, the tips of the wing and/or the edge of the wing can include different materials (shown as darkened areas in FIG. 13B).

### Rotating System Overview

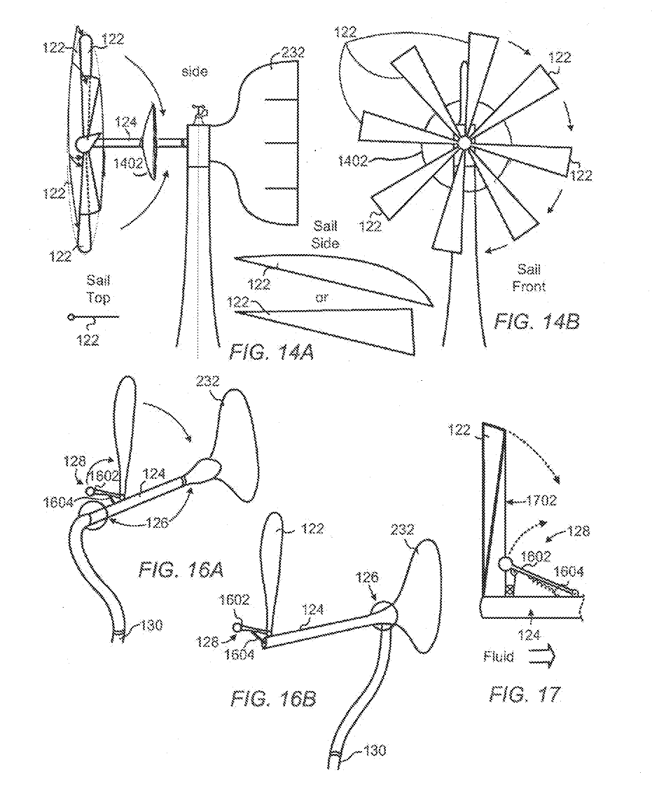

Illustrated in FIGS. 14A and 14B are various views a further embodiment of a device, such as the device 120 shown in FIG. 1. FIG. 14A shows a side view of the device 120. The device comprises a plurality of wings 122, which attach to the shaft 124 and rotate in either a clockwise (as illustrated in FIG. 14B) or counterclockwise direction. The wings 122 may be of any number, size, or shape, as long as the center of gravity of the wings is substantially at the axis of rotation. The wings 122 may be hinged where they mount to the shaft 124 in order to support the actions of the control system 128. The device 120 includes a rudder 232 as described above in reference to FIG. 2A. FIG. 14B illustrates a front view of the device in FIG. 14A.

Referring again to FIG. 14A, the control system 128 comprises a drag scoop 1402 connected to the wings 122 via string, cord, bungee, elastic, springs, or some such mechanism. The drag scoop 1402 mounts around shaft 124 and moves freely along the shaft. The drag scoop 1402 is a device that creates drag in order to generate substantially linear movement. The drag scoop 1402 can be any shape, and may be flat or have curvature to increase drag (see drag scoop 1402 shown by itself to the right of the device, as one example). As the flowing fluid increases speed, the flowing fluid exerts more pressure on the drag scoop 1402, which pushes it backwards along the shaft 124. As the drag scoop 1402 moves backwards (e.g., toward the rudder 232), it pulls on the wings 122, which causes them to fold down towards the shaft 124. As the flowing fluid decreases speed, the flowing fluid exerts less pressure on the drag scoop 1402, and the drag scoop slides forward along the shaft 124. This allows the wings 122 to return to their normal upright position.

Referring now to FIGS. 15A and 15B, illustrated are variations of a control system 128 for a device, such as the device 120 shown in FIG. 14A. For purposes of illustration, FIGS. 15A and 15B show only one wing 122, but there may be any number of wings as described with respect to FIG. 14A above. The control system 128 comprises a drag scoop 1502, a piston 1504, and a movable ring 1506. The drag scoop 1502 is a device that induces drag in order to generate substantially linear movement in response to a high speed fluid flow. The drag scoop 1502 can be any shape, and may be flat or have curvature to increase drag. The piston 1504 is a rod that translates the movement of the drag scoop 1502 to the movable ring 1506. The drag scoop 1502 attaches via a bolt or pivot to a first end of the piston 1504, and the drag scoop 1502 is attached by a bolt or pivot to the generator 126. The movable ring 1506 connects to the wings 122 via string, cord, bungee, elastic, springs, or some such mechanism. The movable ring 1506 also connects to a second end of the piston 1504. The movable ring 1506 is capable of rotating freely around the piston.

Referring now to FIG. 15A, as the flowing fluid increases speed, the flowing fluid exerts more pressure on the drag scoop 1502, which pushes it backwards (toward the rudder 232). This causes the drag scoop 1502 to push the piston 1504 forwards (away from the rudder 232). The piston 1504 pushes the movable ring 1506 forward, which both pushes the wing away from the rudder 232 and pulls the connecting string into the shaft 124, which causes the wings 122 to fold towards the shaft. As the flowing fluid decreases speed, the flowing fluid exerts less pressure on the drag scoop 1502, and the drag scoop slides forward, which moves the piston 1504 backwards. This moves the movable ring 1506 backwards, which allows the base of the wings to move towards the rudder and the connecting string to release from the shaft, and the wings 122 to return to their neutral position. The motion of the drag scoop 1502 and piston 1504 may be aided by a spring, bungee, elastic, nylon, or another such material (not shown).

Referring now to FIG. 15B, as the flowing fluid increases speed, the flowing fluid exerts more pressure on the drag scoop 1502, which pushes it backwards (toward the rudder 232). This causes the drag scoop 1502 to push the piston 1504 forwards (away from the rudder 232). The piston 1504 pushes the movable ring 1506 forward, which pulls the connecting string forward, which folds the wings 122 towards the shaft. As the flowing fluid decreases speed, the flowing fluid exerts less pressure on the drag scoop 1502, and the drag scoop slides forward, which moves the piston 1504 backwards. This moves the movable ring 1506 backwards, which allows the connecting string to relax backwards, allowing the wings 122 to return to their neutral position. The motion of the drag scoop 1502 and piston 1504 may be aided by a spring, bungee, elastic, nylon, or another such material (not shown).

Referring now to FIGS. 16A and 16B, illustrated are variations of a control system 128 for a device, such as the device 120 shown in FIG. 14A. For purposes of illustration, FIGS. 16A and 16B show only one wing 122, but there may be any number of wings as described with respect to FIG. 14A above. The control system 128 comprises a weighted arm 1602 and an elastic connector 1604 for each wing 122. The weighted arm 1602 includes a weight attached to a long lever arm. The weighted arm 1602 connects to the wing 122. The connector 1604 is made of elastic, springs, bungee, nylon, or some such material. The elastic connector 1604 connects between the shaft 124 and the weighted arm 1602. FIGS. 16A and B also show a generator 126 being located along the shaft 124. In FIG. 16A, the generator 126 can be located at either of the positions shown (or there can be two generators, one at each position) at the front of the device before the wing 122 or at the back of the device near the rudder 232.

Referring now to FIG. 16A, as the flowing fluid increases speed, the wings 122 rotate faster around the shaft 124. Through the effects of centrifugal force, the weighted arm 1602 rises farther away from the shaft 124. Since the arm 1602 and the wing 122 are connected, the rising of the arm causes the wing to fold back towards the shaft 124. As the flowing fluid decreases speed, the wings 122 rotate slower around the shaft 124. This allows the weighted arms 1602 to return to their neutral position next to the shaft 124, which allows the wings 122 to return to their upright neutral position. The motion of the weighted arm 1602 is assisted by the connector 1604 by the connector pulling the arm back towards the shaft.

FIG. 16B shows the control system 128 of FIG. 16A located in a different location along the shaft. The control system 128 may be located in front of or behind the base 130.

In various embodiments, the control system 128 illustrated in FIGS. 16A and 16B may contain fewer than one weighted arm 1602 and elastic connector 1604 for each wing 122. The control system may instead use a system of string and pulleys, or gears, or similar such device, to transfer the motion of one weighted arm 1602 to multiple wings 122.

Referring now to FIG. 17, illustrated is a variation of a control system 128 for a device, such as the device 120 shown in FIGS. 16A and 16B. For purposes of illustration, FIG. 17 shows only one wing 122, but there may be any number of wings as described with respect to FIG. 16A above. The control system 128 retains the weighted arm 1602 and connector 1604, and ads a pulley system 1702. The pulley system 1702 comprises string, cord, rope, chain, or some such connector and one or more pulleys. The arm 1602 is connected to the shaft 124 via a hinge, bolt, pivot, or some such device, and the pulley system 1702 connects the weighted arm to the wing 122. Through the effects of centrifugal force, the weighted arm 1602 rises farther away from the shaft 124. The pulley system 1702 translates this motion to the wing 122, which causes the wing to fold back towards the shaft 124. As the flowing fluid decreases speed, the wings 122 rotate slower around the shaft 124. The allows the weighted arms 1602 to return to their neutral position next to the shaft 124, which allows the wings 122 to return to their upright neutral position. The motion of the weighted arm 1602 is assisted by the connector 1604 pulling the arm back towards the shaft.

### Internal Systems

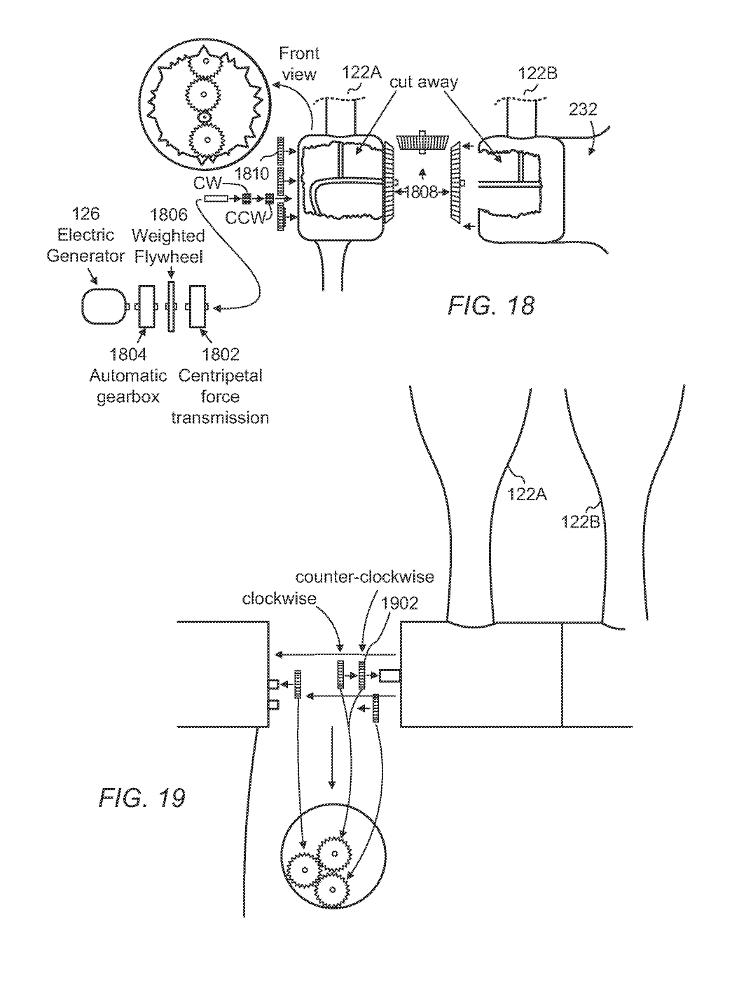

Referring now to FIGS. 18 and 19, illustrated are exploded views of internal mechanisms that can be included in the device, such as in device 120 in FIG. 1, according to one or more embodiments of the invention. The internal mechanisms shown in FIGS. 18 and 19 provide examples of a gearing system and transmission that the system can incorporate to convert the reciprocating motion of the wings 122A and 122B into a non-reciprocating motion, such as rotation of shaft in a single direction, clockwise or counterclockwise. As discussed above, the device can also include a generator 126, such as an electric generator illustrated in FIG. 18, which can be coupled to the transmission to generate an electric voltage that can be used to generate electricity. The designs shown in FIGS. 18 and 19 can be included or used with any of the embodiments described herein.

FIG. 18 illustrates the generator 126 connecting to an automatic gearbox 1804, which connects to a weighted flywheel 1806 that then connects to the centripetal force transmission 1802. The components attach to the rest of the device via a set of ratcheting gears 1810, and transmit through the shaft to the fore wing 122A and the aft wing 122B via gears 1808 that are positioned at the shaft between the two wings 122A and 122B. The rear rudder 232 is shown to the right of FIG. 18. The counterbalance, pendulum, or other control arm can be mounted below the fore wing 122A, as shown in FIG. 18. A reverse rotating gearbox system or other similar device, such as a differential, can be included to make the fore wing 122A and aft wing 122B rotate synchronously in opposite directions related to the structure on which they are mounted and to the rear rudder 232. FIG. 19 illustrates converting reciprocating to unidirectional rotation (e.g., two one-way clutches), including illustrating freewheel mechanism ratcheting gears 1902 that can turn clockwise or counterclockwise to operate the device.

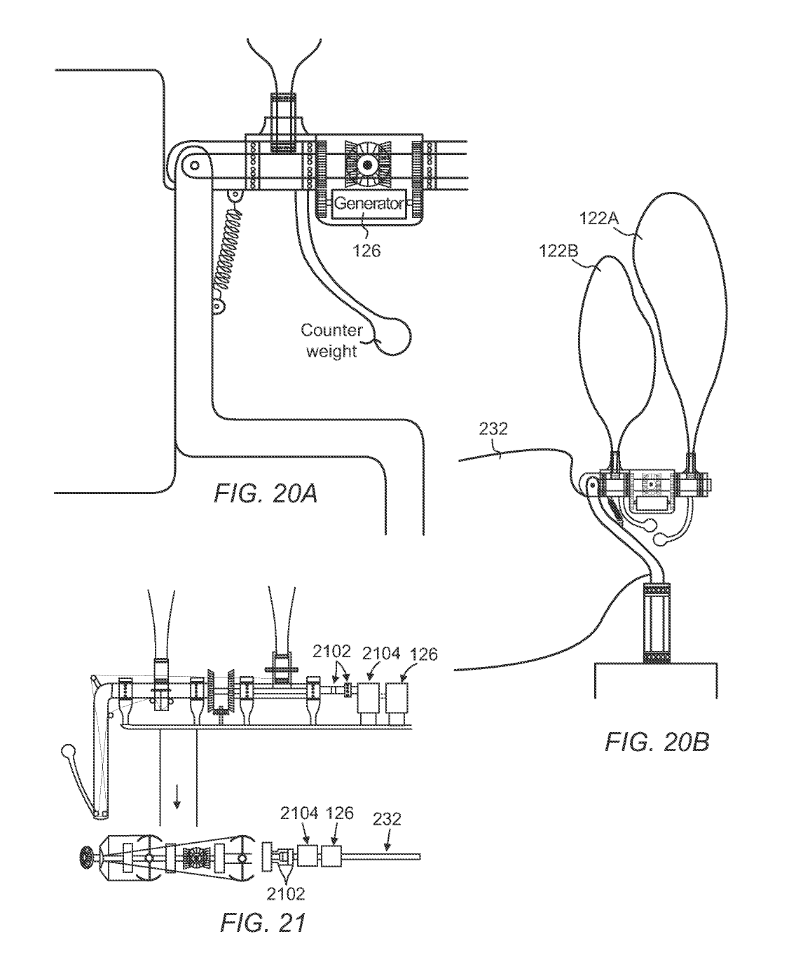

FIGS. 20A and 20B illustrate internal components a device, such as device 120, according to one or more embodiments of the invention. FIG. 20B shows a larger view, also illustrating the wings 122A and 122B, along with the rudder 232. FIG. 20A shows a close-up view of the internal components of the device. In this embodiment, the generator 126 is included below the shaft, which is one example of a positioning for the generator. However, the generator can be positioned at various other locations on the device. FIG. 20B illustrates how the rudder 232 can attach along the length of the base structure on which the device rests.

FIG. 21 illustrates internal components of the shaft of a device, according to one or more embodiments of the invention. In this embodiment, the device can include two generators 126 that are positioned at the shaft of the device. Any number of additional generators can also be included. The device also includes a gearbox 2104 and clutch bearings 2102.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. In addition, throughout the description, sometimes the same number label is used for a corresponding structure for ease of illustration. For example, the number 126 is used for the generator. However, it is to be understood that these do not necessarily all refer to the same component, but instead can refer to a variety of different designs or embodiments of such component. A variety of components are shown in each of the figures. However, it is to be understood that any of the figures can include more, fewer, or different components, as desired. In addition, the components described in figures can be interchanged with components described in other figures. For example, any combination of the control systems described herein can be used with any of the embodiments of the device.

1-41. (canceled)

42. An apparatus for generating a torque from a moving fluid, the apparatus comprising:
a shaft oriented along a shaft axis;
a wing coupled to the shaft, wherein the wing is oriented along a wing axis that is substantially perpendicular to the shaft axis, wherein the wing is rotatable about the shaft from a first shaft axis position to a second shaft axis position, wherein the wing is rotatable about the wing axis from a first wing axis position to a second wing axis position such that the wing presents a first angle of attack when in the first wing axis position and a second angle of attack when in the second wing axis position;
a pendulum pivotable about a pendulum axis from a first pendulum position to a second pendulum position, wherein the pendulum is mechanically coupled to the wing such that when the pendulum transitions from the first pendulum position to the second pendulum position, the wing correspondingly transitions from the first wing axis position to the second wing axis position.

43. The apparatus of claim 42, wherein the pendulum axis is substantially parallel to the shaft axis.

44. The apparatus of claim 43, wherein the pendulum axis is positioned opposite the wing relative to the shaft axis, and wherein the pendulum extends towards the shaft axis.

45. The apparatus of claim 42, further comprising a spring coupled to the pendulum and positioned about the pendulum axis to resist motion of the pendulum about the pendulum axis.

46. The apparatus of claim 42, further comprising a connector coupled to the pendulum and at least one additional component of the apparatus to limit a range of motion of the pendulum.

47. The apparatus of claim 42, further comprising:
a second wing coupled to the shaft, wherein the second wing is oriented along a second wing axis that is substantially perpendicular to the shaft axis, wherein the second wing is rotatable about the shaft from a third shaft axis position to a fourth shaft axis position, wherein the second wing is rotatable about the second wing axis from a third wing axis position to a second wing axis position such that the wing presents a first angle of attack when in the first wing axis position and a second angle of attack when in the second wing axis position;
a second pendulum pivotable about a second pendulum axis from a third pendulum position to a fourth pendulum position, wherein the second pendulum is mechanically coupled to the second wing such that when the second pendulum transitions from the first pendulum position to the second pendulum position, the second wing correspondingly transitions from the third wing axis position to the fourth wing axis position.

48. The apparatus of claim 47, wherein the second wing has a surface area smaller than a surface area of the wing.

49. The apparatus of claim 42, wherein the pendulum is mechanically coupled to the wing such that when the pendulum transitions from the second pendulum position to the first pendulum position, the wing correspondingly transitions from the second wing axis position to the first wing axis position.

50. The apparatus of claim 42, wherein the wing is hinged to the shaft such that the wing is configured to fold towards the shaft.

51. The apparatus of claim 42, further comprising a rudder defining a plane, wherein a normal to the plane is substantially perpendicular to the shaft axis.

52. The apparatus of claim 42, wherein the wing defines a leading edge and a trailing edge, wherein when the wing is in the first wing axis position, the trailing edge is on a first side of the wing axis, and wherein when the wing is in the second wing axis position, the trailing edge is on a second side of the wing axis opposite the first side of the wing axis.

53. The apparatus of claim 42, wherein the pendulum axis is parallel to the wing axis.

54. The apparatus of claim 42, wherein the pendulum axis is co-linear with the wing axis.

55. An apparatus for generating a torque from a moving fluid, the apparatus comprising:
a shaft oriented along a shaft axis;
a wing coupled to the shaft, wherein the wing is oriented along a wing axis that is substantially perpendicular to the shaft axis, wherein the wing is rotatable about the shaft from a first shaft axis position to a second shaft axis position, wherein the wing is rotatable about the wing axis from a first wing axis position to a second wing axis position such that the wing presents a first angle of attack when in the first wing axis position and a second angle of attack when in the second wing axis position;
an elastic connector defining a first end coupled to the wing and a second end coupled to a component of the apparatus that is substantially stationary as the wing pivots about the shaft axis such that when the wing rotates about the shaft axis to the second axis position, the elastic connector pulls the wing to rotate about the wing axis from the first wing axis position to the second wing axis position.

56. An apparatus for generating a torque from a moving fluid, the apparatus comprising:
a shaft oriented along a shaft axis;
a wing coupled to the shaft, wherein the wing is oriented along a wing axis that is substantially perpendicular to the shaft axis, wherein the wing is rotatable about the shaft from a first shaft axis position to a second shaft axis position, wherein the wing is rotatable about the wing axis from a first wing axis position to a second wing axis position such that the wing presents a first angle of attack when in the first wing axis position and a second angle of attack when in the second wing axis position;
a wheel coupled to the wing and rotatable about a wheel axis substantially perpendicular to the wing axis;
a barrier that is substantially stationary as the wing pivots about the shaft axis such and positioned relative to the wheel such that the wheel contacts the barrier as the wing rotates about the shaft axis, wherein the barrier is curved such that as wing rotates about the shaft axis from the first shaft axis position to the second shaft axis position, the wheel exerts a force on the wing causing the wing to transition from the first wing axis position to the second wing axis position.
